(19) United States
(12) Patent Application Publication
(10) Pub. No.: US 2006/0036830 A1
(43) Pub. Date: Feb. 16, 2006

(54) Method for monitoring access to virtual memory pages

(76) Inventors: Christophe de Dinechin, Roguebrune sur Argens (FR); Jonathan Ross, Woodinville, WA (US); Todd Kjos, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/020,432

(22) Filed: Dec. 22, 2004

Related U.S. Application Data
(63) Continuation-in-part of application No. 10/903,900, filed on Jul. 31, 2004, now abandoned.

(51) Int. Cl. G06F 21/00; G06F 9/34

(52) U.S. Cl. 711/200; 711/6

(57) ABSTRACT

Various embodiments of the present invention are directed to efficient methods for virtual-machine monitors to detect, at run time, initial attempts by guest operating systems and other higher-level software to access or execute particular instructions or values corresponding to the particular instructions, that, when accessed for execution, need to be emulated by a virtual-machine monitor, rather than directly accessed by guest operating systems. In certain embodiments of the present invention, the virtual-machine monitor assigns various guest-operating-system-code-containing memory pages to one of a small number of protection-key domains. By doing so, the virtual-machine monitor can arrange for any initial access to the memory pages assigned to the protection-key domains to generate a key-permission fault, after which the key-permission-fault handler of the virtual-machine monitor is invoked to arrange for subsequent, efficient access or emulation of access to the protected pages. In alternative embodiments, protection domains can be implemented by using page-level access rights or translation-lookaside-buffer entry fields.

### CROSS-REFERENCE TO RELATED APPLICATION

This application is a continuation-in-part of U.S. application Ser. No. 10/903,900, filed Jul. 31, 2004.

### TECHNICAL FIELD

The present invention is related to computer architecture, operating systems, and virtual-machine monitors, and, in particular, to methods, and virtual-machine monitors incorporating the methods, for monitoring access to virtual memory pages to ensure that the contents of the virtual memory pages are appropriate for the type of each access operation.

### BACKGROUND OF THE INVENTION

During the past 50 years, computer hardware, architecture, and operating systems that run on computers have evolved to provide ever-increasing storage space, execution speeds, and features that facilitate computer intercommunication, security, application-program development, and ever-expanding range of compatibilities and interfaces to other electronic devices, information-display devices, and information-storage devices. In the 1970's, enormous strides were made in increasing the capabilities and functionalities of operating systems, including the development and commercial deployment of virtual-memory techniques, and other virtualization techniques, that provide to application programs the illusion of extremely large address spaces and other virtual resources. Virtual memory mechanisms and methods provide 32-bit or 64-bit memory-address spaces to each of many user applications concurrently running on computer system with far less physical memory.

Virtual machine monitors provide a powerful new level of abstraction and virtualization. A virtual machine monitor comprises a set of routines that run directly on top of a computer machine interface, and that, in turn, provides a virtual machine interface to higher-level programs, such as operating systems. An operating system, referred to as a “guest operating system,” runs above, and interfaces to, a well-designed and well-constructed virtual-machine interface just as the operating system would run above, and interface to, a bare machine.

A virtual-machine monitor uses many different techniques for providing a virtual-machine interface, essentially the illusion of a machine interface to higher-level programs. A virtual-machine monitor may pre-process operating system code to replace privileged instructions and certain other instructions with patches that emulate these instructions. The virtual-machine monitor generally arranges to intercept and emulate the instructions and events which behave differently under virtualization, so that the virtual-machine monitor can provide virtual-machine behavior consistent with the virtual machine definition to higher-level software programs, such as guest operating systems and programs that run in program-execution environments provided by guest operating systems. The virtual-machine monitor controls physical machine resources in order to fairly allocate physical machine resources among concurrently executing operating systems and preserve certain physical machine resources, or portions of certain physical machine resources, for exclusive use by the virtual-machine monitor.

Although, theoretically, a virtual-machine monitor might be able to completely pre-process guest-operating-system code in order to arrange for proper emulation of all privileged instructions and proper emulation of all access to privileged resources, in fact, the task is generally too complex to be readily and cost-effectively solved. In particular, there are a number of instructions that do not generate privileged-instruction faults in certain processor architectures, but that need to be emulated by a virtual-machine monitor. Furthermore, it is often not possible, beforehand, to identify whether memory values corresponding to these instructions are, in fact, stored instructions, or are, instead, stored data. Therefore, designers, implementers, manufacturers, and users of virtual-machine monitors and virtual-monitor-containing computer systems have recognized the need for an efficient method by which virtual-machine monitors can intercept attempts by guest operating systems to dynamically access non-privileged instructions needing emulation, at run time.

### SUMMARY OF THE INVENTION

Embodiments of the present invention are generally directed to monitoring access to a virtual memory pages to ensure that the contents of the virtual memory page are appropriate for each access operation. Various embodiments of the present invention useful for virtual-machine-monitor implementations are directed to efficient methods for virtual-machine monitors to detect, at run time, initial attempts by guest operating systems and other higher-level software to access or execute particular instructions or values corresponding to the particular instructions, that, when accessed for execution, need to be emulated by a virtual-machine monitor, rather than directly accessed by guest operating systems. In certain embodiments of the present invention, the virtual-machine monitor assigns various guest-operating-system-code-containing memory pages to one of a small number of protection domains implemented as protection-key domains. By doing so, the virtual-machine monitor can arrange for any initial access to the memory pages assigned to the protection-key domains to generate a key-permission fault, after which the key-permission-fault handler of the virtual-machine monitor is invoked to arrange for subsequent, efficient access or emulation of access to the protected pages. In alternative embodiments, protection domains can be implemented by using page-level access rights or translation-lookaside-buffer entry fields.

### BRIEF DESCRIPTION OF THE DRAWINGS

FIG. 1 illustrates virtual memory provided by a combined operating-system/hardware system.

FIG. 2 illustrates a monitor-based approach to supporting multiple, concurrently executing operating systems.

FIGS. 3A-B show the registers within an Itanium processor.

FIG. 4 illustrates the virtual address space provided by one modern computer architecture.

FIG. 5 illustrates translation of a virtual memory address into a physical memory address via information stored within region registers, protection key registers, and a translation look-aside buffer.

FIG. 6 shows the data structures employed by an operating system to find a memory page in physical memory corresponding to a virtual memory address.

FIG. 7 shows the access rights encoding used in a TLB entry.

FIGS. 8A-B provide details of the contents of a region register and the contents of a VHPT long-format entry.

FIGS. 9A-B provide additional details about the virtual-memory-to-physical-memory translation caches and the contents of translation-cache entries.

FIG. 10 provides additional details regarding the contents of protection-key registers.

FIGS. 11-18 illustrate techniques used by a virtual-machine monitor for dynamic guest-operating-system code patching according to one embodiment of the present invention.

FIG. 19 a control-flow diagram illustrating initial assignment of a virtual-memory page by a virtual-machine monitor to one of the three, above-described protection-key domains.

FIG. 20 is a control-flow diagram illustrating logic added to the key-permission-fault handler of a virtual-machine monitor to implement one embodiment of the present invention.

### DETAILED DESCRIPTION OF THE INVENTION

Various specific embodiments of the present invention are directed to efficient mechanisms by which a virtual-machine monitor can patch instructions in guest-operating-system executable code, in order to emulate certain instructions that would not correctly execute in the virtual-machine environment provided by the virtual-machine monitor. In one approach to executing guest operating systems in virtual-monitor-provided virtual-machine environments, the guest-operating-system executable code is first pre-processed, in its entirety, and instructions identified for emulation are patched, or replaced, generally by branch instructions to virtual-monitor executable patches that perform instruction emulation. Unfortunately, such pre-processing requires detailed understanding of the guest-operating-system executable code. In particular, since the contents of a 64-bit memory word may appear to have the format of an instruction, but actually be used as data, and, conversely, a 64-bit word may appear to contain an integer data value, but may subsequently be executed, it is difficult, during pre-processing, to ambiguously decide whether a particular memory page constitutes executable code or represents stored data used by executable code. In most modern operating systems, each virtual-memory page is employed either as data or as executable code, although, in certain rare cases, both data and executable code may be mixed on a single virtual-memory page and, in other rare cases, executable code may be written to a data page and subsequently executed. The intimate knowledge of guest-operating-system behavior needed to unambiguously identify all instructions within guest-operating-system code that need to be emulated by a virtual-machine monitor makes guest-operating-system code difficult, and often commercially impractical, to port to virtual-machine environments provided by virtual-machine monitors. In many cases, a well-conceived pre-processing routine may use heuristical methods and careful analysis of guest-operating-system code to unambiguously determine, for most cases, whether a virtual-memory page contains data or executable code. However, as with all programs, but especially with operating systems, even a few incorrect assumptions can lead to disastrous consequences that are difficult to debug. Moreover, certain instructions that need to be emulated may not be privileged, and therefore do not automatically fault when executed at guest-operating-system privilege. For this reason, designers, implementers, vendors, and users of virtual-machine monitors have recognized the need for an efficient method for patching guest-operating-system code in order to detect initial access to the instructions and emulate execution of the instructions, but in a way that is dynamic and reversible, at run time, in order to handle those cases where initial determinations prove to be either incorrect or partially correct. A described embodiment makes use of Intel Itanium® architecture features. Additional information concerning virtual memory, virtual-machine monitors, and the Itanium architecture are first provided, in the present invention, in a subsequent subsection.

### Additional Information about Virtual Memory, Virtual Monitors, and the Intel® Itanium Computer Architecture

Virtual Memory

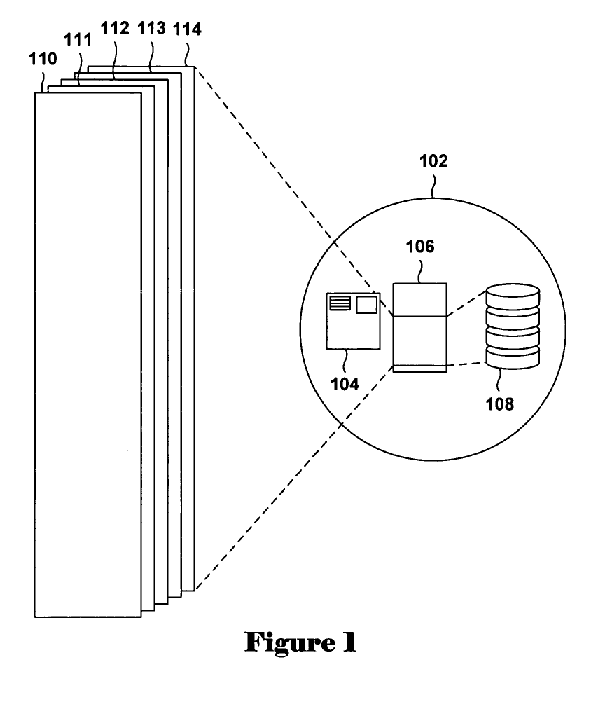

FIG. 1 illustrates virtual memory provided by a combined operating-system/hardware system. In FIG. 1, the operating system is abstractly represented as a circle 102 enclosing hardware components including a processor 104, physical memory 106, and mass-storage devices 108. FIG. 1 is intended to abstractly represent certain features of the hardware system, or machine, rather than to accurately represent a machine or enumerate the components of a machine. In general, the operating system provides, to each process executing within the execution environment provided by the operating system, a large virtual-memory address space, represented in FIG. 1 by vertical columns external to the operating system, such as vertical column 110. The virtual-memory address space defines a sequence of addressable memory bytes with addresses ranging from 0 to 2⁶-1 for a combined operating-system/hardware system supporting 64-bit addresses. The Itanium virtual address space is up to 85 bits wide, comprising a 61-bit offset and a 24-bit region selector, with a 64-bit address space accessible at any point in time. Depending on the machine and operating system, certain portions of the virtual-memory address space may be inaccessible to a process, and various mechanisms may be used to extend the size of the virtual-memory address space beyond the maximum size addressable by the machine-supported addressing unit. An operating system generally provides a separate virtual-memory address space to each process concurrently executing on top of the operating system, so that, as shown in FIG. 1, the operating system may simultaneously support a number of distinct and separate virtual-memory address spaces 110-114.

A virtual-memory address space is, in many respects, an illusion created and maintained by the operating system. A process or thread executing on the processor 104 can generally access only a portion of physical memory 106. Physical memory may constitute various levels of caching and discrete memory components distributed between the processor and separate memory integrated circuits. The physical memory addressable by an executing process is often smaller than the virtual-memory address space provided to a process by the operating system, and is almost always smaller than the aggregate size of the virtual-memory address spaces simultaneously provided by the operating system to concurrently executing processes. The operating system creates and maintains the illusion of relatively vast virtual-memory address spaces by storing the data, addressed via a virtual-memory address space, on mass-storage devices 108 and rapidly swapping portions of the data, referred to as pages, into and out from physical memory 106 as demanded by virtual-memory accesses made by executing processes. In general, the patterns of access to virtual memory by executing programs are highly localized, so that, at any given instant in time, a program may be reading to, and writing from, only a relatively small number of virtual-memory pages. Thus, only a comparatively small fraction of virtual-memory accesses require swapping of a page from mass-storage devices 108 to physical memory 106.

Virtual Monitors

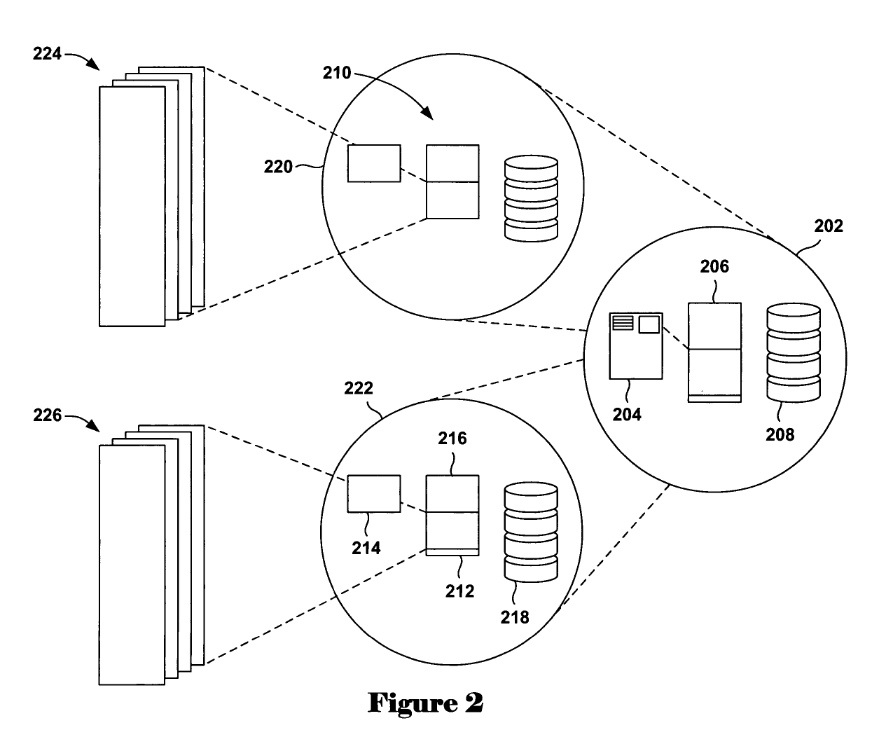

A virtual-machine monitor is a set of routines that lie above the physical machine interface, and below all other software routines and programs that execute on a computer system. A virtual-machine monitor, also referred to as a “hypervisor” or simply as a “monitor,” provides a virtual-machine interface to each operating system concurrently executing on the computer system. The virtual-machine interface includes those machine features and characteristics expected of a machine by operating systems and other programs that execute on machines. For example, a virtual-machine interface includes a virtualized virtual-memory-system interface. FIG. 2 illustrates a virtual-monitor-based approach to supporting multiple, concurrently executing operating systems. In FIG. 2, a first circle 202 encloses the physical processor 204, physical memory 206, and mass-storage devices 208 of a computer system. The first enclosing circle 202 represents a virtual-machine monitor, a software layer underlying the traditional operating-system software layer of the computer system. The virtual-machine monitor provides virtual-machine interfaces 210 and 212. The virtual machine can be considered to include a virtual processor, virtual physical memory, and virtual mass-storage devices, e.g., 214, 216, 218, respectively. An operating system software layer can be considered to encapsulate each virtual machine, such as operating systems 220 and 222 represented by circles in FIG. 2. In turn, the operating systems each provide a number of guest-virtual-memory address spaces 224 and 226 to processes concurrently executing within the execution environments provided by the operating systems. The virtual-machine monitor may provide multiple virtual processors to guest operating systems, and may provide a different number of virtual processors than the number of physical processors contained in the computer system.

Intel Itanium® Architecture

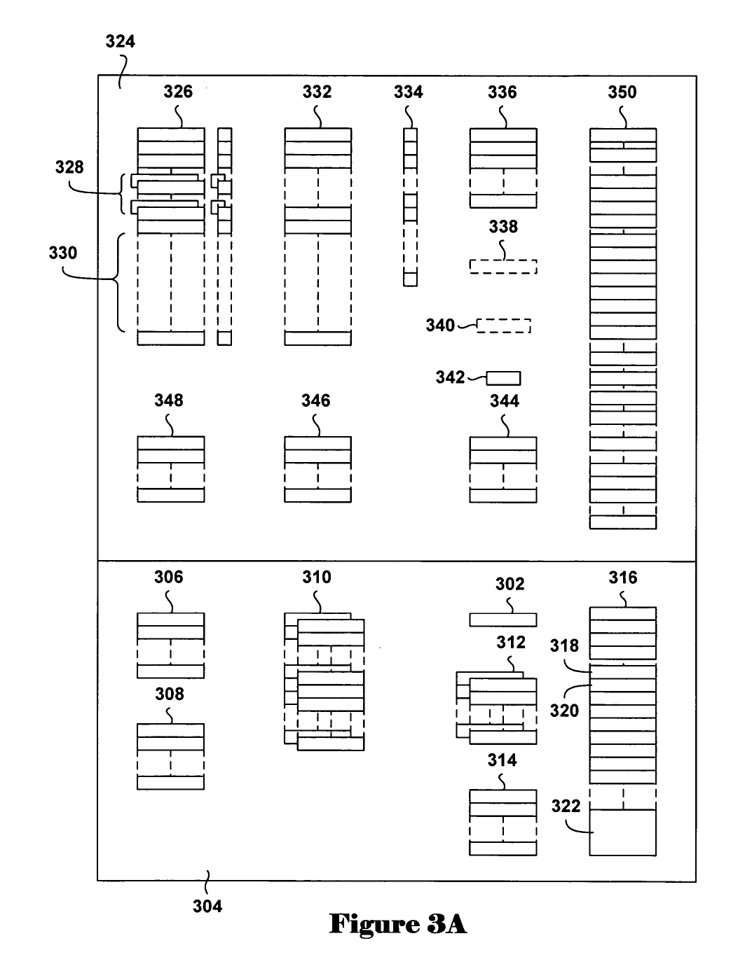

Processors, such as Intel Itanium® processors, built to comply with the Intel® Itanium computer architecture represent one example of a modern computer hardware platform suitable for supporting a monitor-based virtual machine that in turn supports multiple guest-operating-systems, in part by providing a virtual physical memory and virtual-address translation facilities to each guest operating system. FIGS. 3A-B show the registers within an Itanium processor. FIG. 3A is a block diagram showing the registers within the processor. The registers hold values that define the execution state of the processor, and, when saved to memory, capture the machine state of an executing process prior to stopping execution of the process. Restoring certain registers saved in memory allows for resumption of execution of an interrupted process. The register set shown in FIGS. 3A-B is quite complex, and only certain of the registers are described, below.

The process status register (“PSR”) 302 is a 64-bit register that contains control information for the currently executing process. The PSR comprises many bit fields, including a 2-bit field that contains the current privilege level (“CPL”) at which the currently executing process is executing. There are four privilege levels: 0, 1, 2, and 3. The most privileged privilege level is privilege level 0. The least privileged privilege level is privilege level 3. Only processes executing at privilege level 0 are allowed to access and manipulate certain machine resources, including the subset of registers, known as the “system-register set,” shown in FIG. 3A within the lower rectangle 304. One control register, the interruption processor status register (“IPSR”) 318, stores the value of the PSR for the most recently interrupted process. The interruption status register (“ISR”) 320 contains a number of fields that indicate the nature of the interruption that most recently occurred to an interruption handler when the PSR.ic field flips from “1,” at the time of a fault or interrupt, to “0” as the interruption handler is invoked. Other control registers store information related to other events, such as virtual memory address translation information related to a virtual address translation fault, pointers to the last successfully executed instruction bundle, and other such information. Sets of external interrupt control registers 322 are used, in part, to set interrupt vectors. The IHA register stores an indication of a virtual hash page table location at which the virtual-address translation corresponding to a faulting virtual address should be found.

The registers shown in FIG. 3A in the upper rectangular region 324 are known as the “application-register set.” These registers include a set of general registers 326, sixteen of which 328 are banked in order to provide immediate registers for interruption handling code. At least 96 general registers 330 form a general-register stack, portions of which may be automatically stored and retrieved from backing memory to facilitate linkages among calling and called software routines. The application-register set also includes floating point registers 332, predicate registers 334, branch registers 336, an instruction pointer 338, a current frame marker 340, a user mask 342, performance monitor data registers 344, processor identifiers 346, an advanced load address table 348, and a set of specific application registers 350.

FIG. 3B shows another view the registers provided by the Itanium architecture, including the 128 64-bit general purpose registers 354, a set of 128 82-bit floating point registers 356, a set of 64 predicate registers 358, a set of 64 branch registers 360, a variety of special purpose registers including application registers (“AR”) AR₀ through AR₁₂₇ 366, an advance load address table 368, process-identifier registers 370, performance monitor data registers 372, the set of control registers (“CR”) 374, ranging from CR₀ to CR₈₁, the PSR register 376, break point registers 378, performance monitor configuration registers 380, a translation lookaside buffer 382, region registers 384, and protection key registers 386. Note that particular AR registers and CR registers have acronyms that reflect their use. For example, AR register AR₁₇ 388, the backing-store-pointer register, is associated with the acronym BSP, and this register may be alternatively specified as the BSP register or the AR[BSP] register. In many of the registers, single bits or groups of bits comprise fields containing values with special meanings. For example, the two least significant bits within register AR[RSC] 390 together compose a mode field which controls how aggressively registers are saved and restored by the processor. These two bits can be notationally specified as “AR[RSC].mode.”

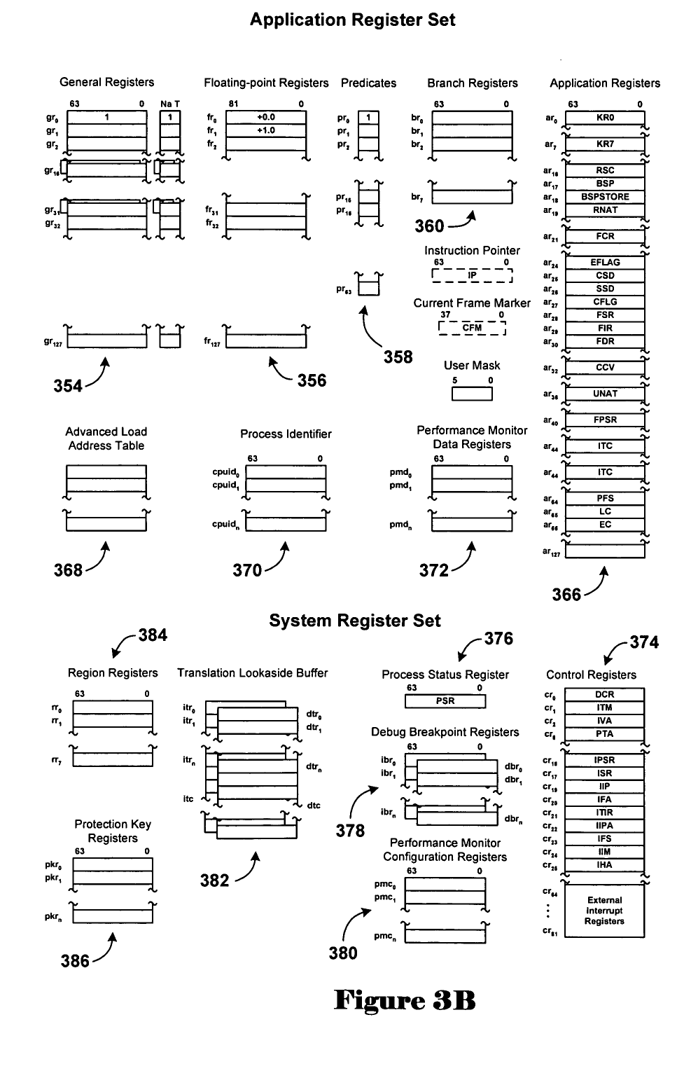

The memory and virtual-address-translation architecture of the Itanium computer architecture is described below, with references to FIGS. 4-7. The virtual address space defined within the Intel Itanium computer architecture includes 2²⁴ regions, such as regions 402-407 shown in FIG. 4, each containing 2⁶ bytes that are contiguously addressed by successive virtual memory addresses. Thus, the virtual memory address space can be considered to span a total address space of 2⁸⁵ bytes of memory. An 85-bit virtual memory address 408 can then be considered to comprise a 24-bit region field 410 and a 61-bit address field 412.

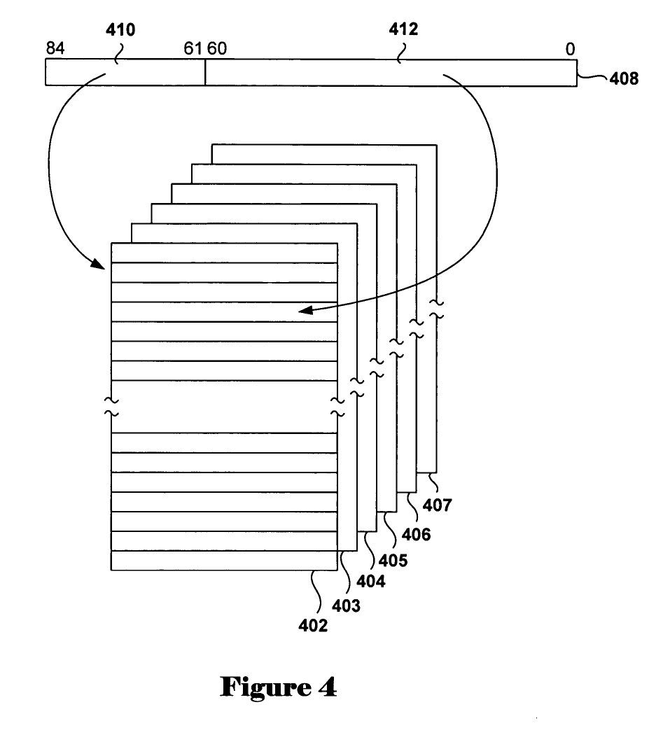

In general, however, virtual memory addresses are encoded as 64-bit quantities. FIG. 5 illustrates translation of a 64-bit virtual memory address into a physical memory address via information stored within region registers, protection key registers, and a translation look-aside register buffer (“TLB”). In the Intel® Itanium architecture, virtual addresses are 64-bit computer words, represented in FIG. 5 by a 64-bit quantity 502 divided into three fields 504-506. The first two fields 504 and 505 have sizes that depend on the size of a memory page, which can be adjusted within a range of memory page sizes. The first field 504 is referred to as the “offset.” The offset is an integer designating a byte within a memory page. If, for example, a memory page contains 4096 bytes, then the offset needs to contain 12 bits to represent the values 0-4095. The second field 505 contains a virtual page address. The virtual page address designates a memory page within a virtual address space that is mapped to physical memory, and further backed up by memory pages stored on mass storage devices, such as disks. The third field 506 is a three-bit field that designates a region register containing the identifier of a region of virtual memory in which the virtual memory page specified by the virtual page address 505 is contained.

One possible virtual-address-translation implementation consistent with the Itanium architecture is next discussed. Translation of the virtual memory address 502 to a physical memory address 508 that includes the same offset 510 as the offset 504 in the virtual memory address, as well as a physical page number 512 that references a page in the physical memory components of the computer system, is carried out by the processor, at times in combination with operating-system-provided services. If a translation from a virtual memory address to a physical memory address is contained within the TLB 514, then the virtual-memory-address-to-physical-memory-address translation can be entirely carried out by the processor without operating system intervention. The processor employs the region register selector field 506 to select a register 516 within a set of region registers 518. The selected region register 516 contains a 24-bit region identifier. The processor uses the region identifier contained in the selected region register and the virtual page address 505 together in a hardware function to select a TLB entry 520 containing a region identifier and virtual memory address that match the region identifier contained in the selected region register 516 and the virtual page address 505. Each TLB entry, such as TLB entry 522, contains fields that include a region identifier 524, a protection key associated with the memory page described by the TLB entry 526, a virtual page address 528, privilege and access mode fields that together compose an access rights field 530, and a physical memory page address 532.

If a valid entry in the TLB, with present bit=1, can be found that contains the region identifier contained within the region register specified by the region register selector field of the virtual memory address, and that entry contains the virtual-page address specified within the virtual memory address, then the processor determines whether the virtual-memory page described by the virtual-memory address can be accessed by the currently executing process. The currently executing process may access the memory page if the access rights within the TLB entry allow the memory page to be accessed by the currently executing process and if the protection key within the TLB entry can be found within the protection key registers 534 in association with an access mode that allows the currently executing process access to the memory page. Protection-key matching is required only when the PSR.pk field of the PSR register is set. The access rights contained within a TLB entry include a 3-bit access mode field that indicates one, or a combination of, read, write, and execute privileges, and a 2-bit privilege level field that specifies the privilege level needed by an accessing process. Each protection key register contains a protection key of up to 24 bits in length associated with an access mode field specifying allowed read, write, and execute access modes and a valid bit indicating whether or not the protection key register is currently valid. Thus, in order to access a memory page described by a TLB entry, the accessing process needs to access the page in a manner compatible with the access mode associated with a valid protection key within the protection key registers and associated with the memory page in the TLB entry, and needs to be executing at a privilege level compatible with the privilege level associated with the memory page within the TLB entry.

If an entry is not found within the TLB with a region identifier and a virtual page address equal to the virtual page address within the virtual memory address and a region identifier selected by the region register selection field of a virtual memory address, then a TLB miss occurs and hardware may attempt to locate the correct TLB entry from an architected mapping control table, called the virtual hash page table (“VHPT”), located in protected memory, using a hardware-provided VHPT walker. If the hardware is unable to locate the correct TLB entry from the VHPT, a TLB-miss fault occurs and a kernel or operating system is invoked in order to find the specified memory page within physical memory or, if necessary, load the specified memory page from an external device into physical memory, and then insert the proper translation as an entry into the VHPT and TLB. If, upon attempting to translate a virtual memory address to a physical memory address, the kernel or operating system does not find a valid protection key within the protection key registers 534, if the attempted access by the currently executing process is not compatible with the access mode in the TLB entry or the read/write/execute bits within the protection key in the protection key register, or if the privilege level at which the currently executing process executes is less privileged than the privilege level needed by the TLB entry, then a fault occurs that is handled by a processor dispatch of execution to operating system code.

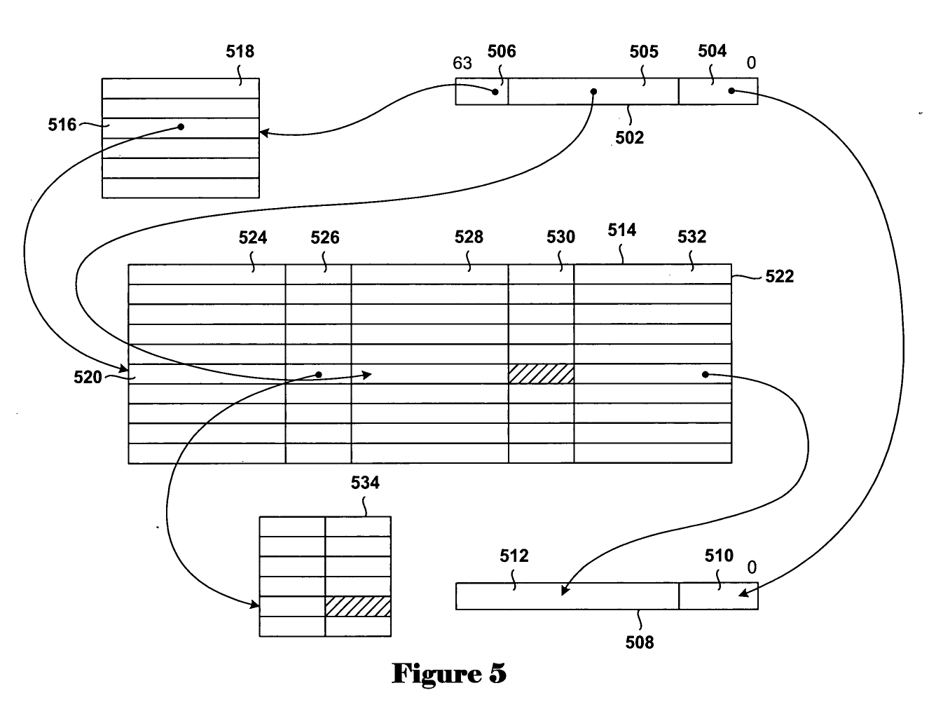

FIG. 6 shows one form of a data structure employed by an operating system to find a memory page in physical memory corresponding to a virtual memory address. The virtual memory address 502 is shown in FIG. 6 with the same fields and numerical labels as in FIG. 5. The operating system employs the region selector field 506 and the virtual page address 505 to select an entry 602 within a virtual page table 604. The virtual page table entry 602 includes a physical page address 606 that references a page 608 in physical memory. The offset 504 of the virtual memory address is used to select the appropriate byte location 610 in the virtual memory page 608. The virtual page table 602 includes a bit field 612 indicating whether or not the physical address is valid. If the physical address is not valid, then the operating system commonly selects a memory page within physical memory to contain the memory page, and retrieves the contents of the memory page from an external storage device, such as a disk drive 614. The virtual page table entry 602 contains additional fields from which the information needed for a TLB entry can be retrieved. Once the operating system successfully maps the virtual memory address into a physical memory address, that mapping is entered into the virtual page table entry and, formatted as a TLB entry, is inserted into the TLB.

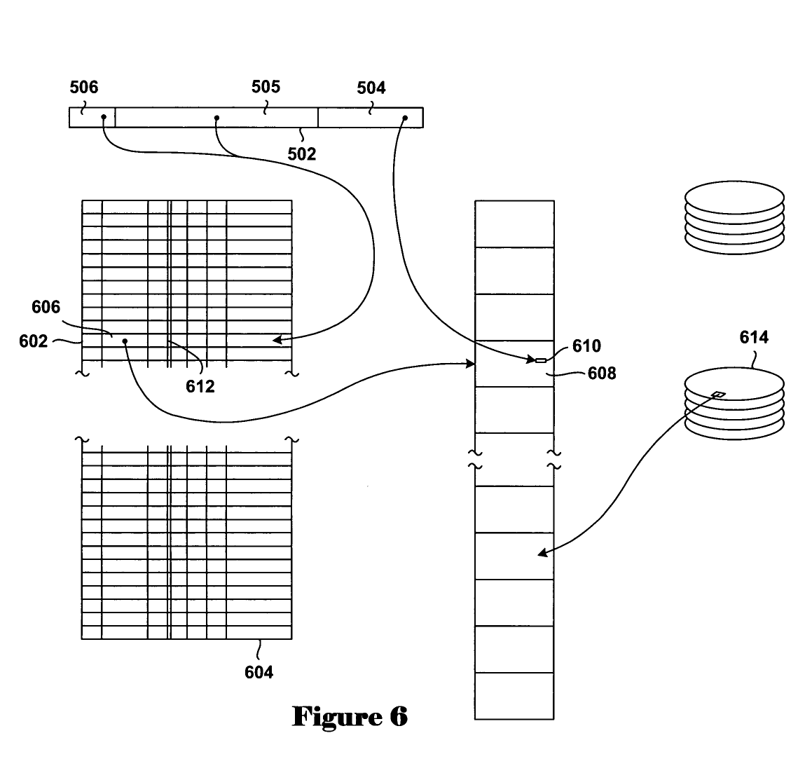

FIG. 7 shows the access rights encoding used in a TLB entry. Access rights comprise a 3-bit TLB.ar mode field 702 that specifies read, write, execute, and combination access rights, and a 2-bit TLB.pl privilege level field 704 that specifies the privilege level associated with a memory page. In FIG. 7, the access rights for each possible value contained within the TLB.ar and TLB.pl fields are shown. Note that the access rights depend on the privilege level at which a current process executes. Thus, for example, a memory page specified with a TLB entry with TLB.ar equal to 0 and TLB.pl equal to 3 can be accessed for reading by processes running at any privilege level, shown in FIG. 7 by the letter “R” in the column corresponding to each privilege level 706-709, while a memory page described by a TLB entry with TLB.ar equal to 0 and TLB.pl equal to 0 can be accessed by reading only by a process running at privilege level 0, as indicated in FIG. 7 by the letter “R” 710 under the column corresponding to privilege level 0. The access rights described in FIG. 7 nest by privilege level according to the previous discussion with reference to FIG. 4. In general, a process running at a particular privilege level may access a memory page associated with that privilege level and all less privileged privilege levels. Using only the access rights contained in a TLB entry, it is not possible to create a memory region accessible to a process running at level 3 and the kernel running at level 0, but not accessible to an operating system running at privilege level 2. Any memory page accessible to a process running at privilege level 3 is also accessible to an operating system executing at privilege level 2.

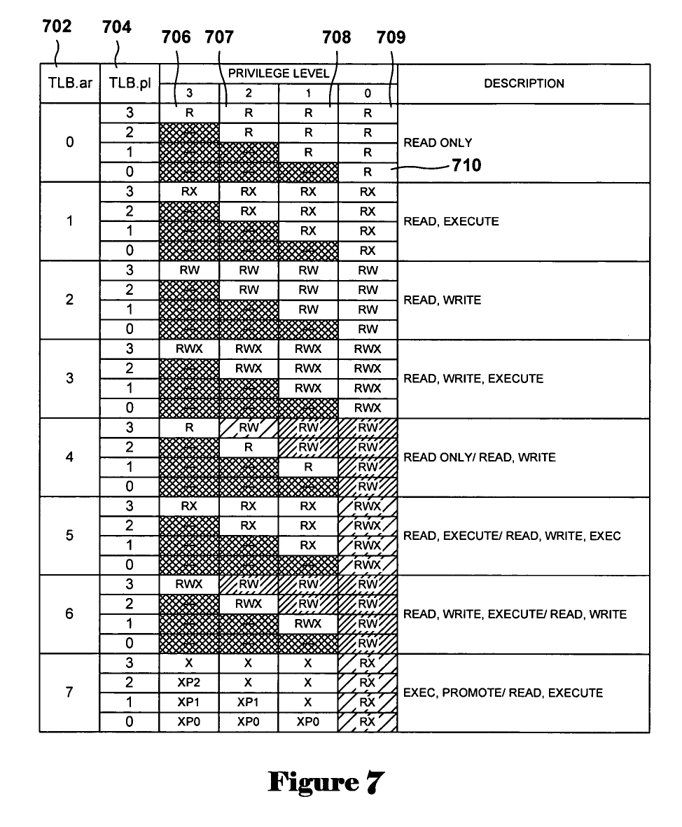

FIGS. 8A-B provide details of the contents of a region register and the contents of a VHPT long-format entry, respectively. As shown in FIG. 8A, a region register includes the following fields: (1) “ve,” a 1-bit Boolean field indicating whether or not the VHPT walker is enabled; (2) “ps,” a 6-bit field indicating a preferred page size for the region, where the preferred page size is 2^{ps}; and (3) “RID,” a 24-bit region identifier. A VHPT long-format entry, as shown in FIG. 8B, includes the following fields: (1) “p,” a 1-bit Boolean field indicating whether or not the corresponding page is resident in physical memory and other fields in the entry contain meaningful information; (2) “ma,” a 3-bit field, called “memory attribute,” which describes caching, coherency, write-policy, and speculative characteristics of the mapped physical page; (3) “a,” a 1-bit field that, when zero, causes references to the corresponding page to generate access faults; (4) “d,” a 1-bit Boolean field that specifies generation of dirty-bit faults upon store or semaphore references to the corresponding page; (5) “pl,” a 2-bit field indicating the privilege level for the corresponding page; (6) “ar,” a 3-bit access-rights field that includes the read, write, and execute permissions for the page; (7) “ppn,” a 38-bit field that stores the most significant bits to the mapped physical address; (8) “ed,” a 1-bit Boolean field whose value contributes to determining whether to defer a speculative load instruction; (9) “ps,” a 6-bit field indicating the page size for virtual-memory mapping; (10) “key,” a protection key associated with the corresponding virtual page; (11) “tag,” a translation tag used for hash-base searching of the VHPT; and (12) “ti,” a 1-bit Boolean field indicating whether or not the translation tag is valid.

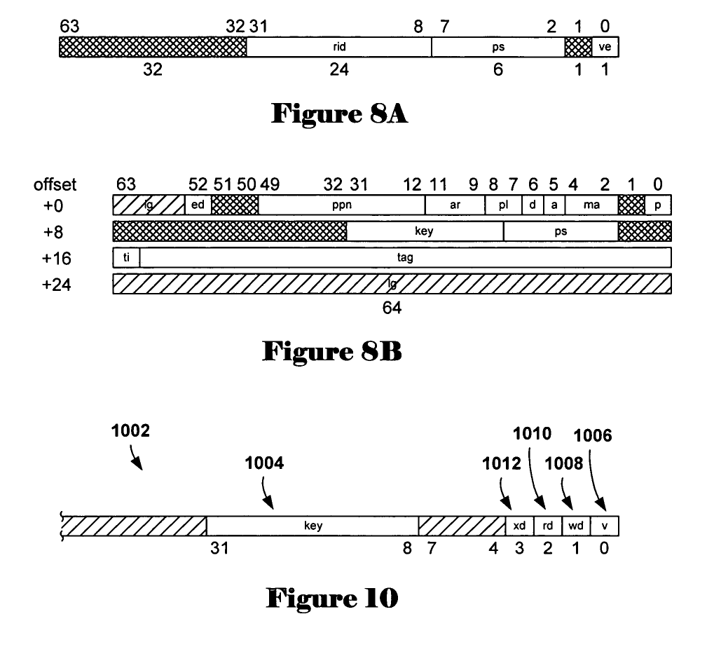

FIGS. 9A-B provide additional details about the virtual-memory-to-physical-memory translation caches and the contents of translation-cache entries. The Itanium provides four translation structures, as shown in FIG. 9A. These include an instruction TLB (“ITLB”), a data TLB (“DTLB”) 904, a set of instruction translation registers (“ITRs”) 906, and a set of data translation registers (“DTRs”) 908. The four translation structures are together referred to as the “TLB.” Entries are placed into the ITLB, DTLB, ITRs, and DTRs by using the privileged instructions itc.i, itc.d, itr.i, and itr.d, respectively. As discussed above, the ITLB and DTLB serve as a first cache for virtual-memory-to-physical-memory translations.

FIG. 9B shows the contents of registers used to insert translation-cache entries into the TLB using the above-described privileged instructions. The contents of four different registers are employed: (1) a general register 910 specified as an operand to the privileged instruction, the interruption TLB insertion register (“ITIR”) 912, the interruption faulting address register (“IFA”) 914, and the contents of the region register 916 selected by the most significant 3 bits of the IFA register 914. Many of the fields shown in FIG. 9B are identical to the fields in the VHPT long-format entry, shown in FIG. 8B, and are not again described, in the interest of brevity. The field “vpn” in the IFA register contains the most significant bits of a virtual-memory address. In both a VHPT entry and a translation-cache entry, the most significant bits of a physical page address and virtual-memory-page address (with page-offset bits assumed to be 0) represent the address of a first byte of a physical page and virtual-memory page, respectively. Thus, VHPT entries and TLB entries are referred to as corresponding both to virtual-memory addresses and to virtual-memory pages. The unspecified, least-significant bits of a physical-memory address or virtual-memory address an offset, in bytes, within the physical memory or virtual memory page specified by the most significant bits.

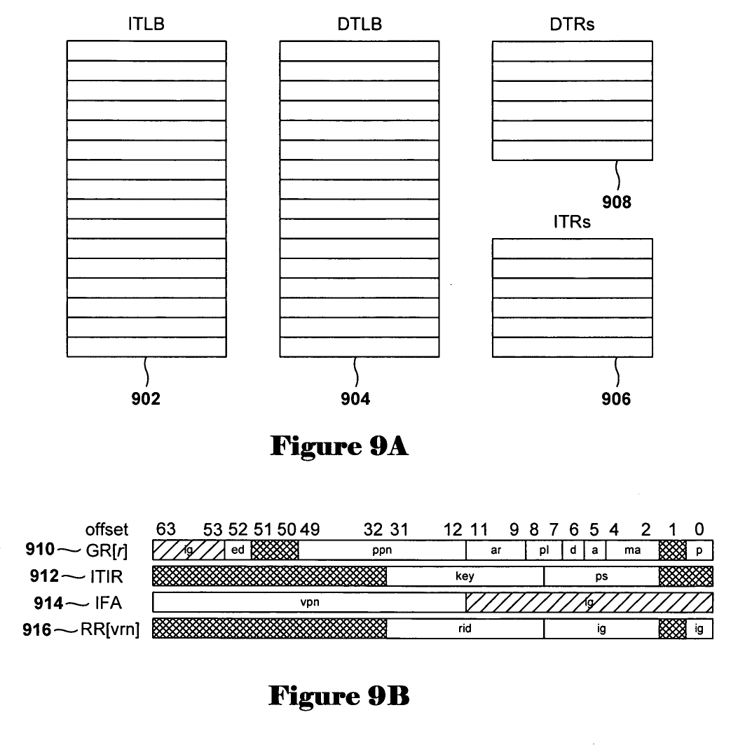

FIG. 10 provides additional details regarding the contents of protection-key registers. The format for a protection-key register 1002 includes a 24-bit key field 1004 and four different single-bit fields that include: (1) a valid bit 1006, which indicates whether or not the protection-key register contains valid contents and is therefore employed by the processor during virtual-address translation; (2) a write-disable bit 1008, which, when set, results in write access denied to pages, the translations for which include the protection key contained in the protection-key field 1004; (3) a read-disable bit, which, when set, disables read access to pages, the translations for which contain the key contained in the key field 1004; and (4) an execute-disable bit 1012, which, when set, prevents execute access to pages, the translations for which contain the key contained in the key field 1004. The read-disable, write-disable, and execute-disable bits in protection key registers provide an additional mechanism to control access to pages, on a key-domain basis rather than on a per-page-access-rights basis.

### Embodiments of the Present Invention

The present invention is described, below, as general, dynamic page-access detection methods and instruction emulation methods. The present invention is particularly useful for implementing virtual-machine monitors on Itanium processors. A particular problem in the Itanium architecture is that certain instructions, including the thash, ttag, and cover instructions, are not privileged, and execution of these instructions is therefore not easily intercepted by a virtual-machine monitor. However, these instructions need to be emulated by a virtual-machine monitor on behalf of guest operating systems. Both ttag and thash use values of other registers that are virtualized by a virtual-machine monitor on behalf of a guest operating system. If the guest operating system were allowed to execute these instructions, the guest operating system would obtain unexpected values, since the guest operating system expects values to be returned based on the virtualized registers, rather than on the actual machine registers that thash and ttag instructions use. The cover instruction behaves differently depending on the machine state encoded in the PSR, virtualized by the virtual-machine monitor for the guest operating system. The virtual PSR may not have the same contents as the actual PSR, and so the cover instruction my not behave as the guest operating system expects it to. Because thash, ttag, and cover instructions are not privileged, they do not fault when called by guest operating system routines running a privilege levels greater than 0, or, in other words, at guest-operating-system privilege. The virtual-machine monitor cannot therefore easily intercept attempts by a guest operating system to execute thash, ttag, and cover instructions. Therefore, the virtual-machine monitor needs to patch ttag, thash, and cover instructions by various methods including: (1) replacing the thash, ttag, and cover instructions with branch instructions that direct execution to one or more instruction that emulate thash, ttag, and cover instructions; and (2) replacing the thash, ttag, and cover instructions with instructions that do generate faults at guest-operating-system privilege, allowing the virtual-machine monitor to intercept attempts by guest operating systems to execute thash, ttag, and cover instructions. However, the virtual-machine monitor cannot patch thash, ttag, and cover instructions in advance of knowing, for sure, whether or not the instructions are executed, or are instead simply data values that look like instructions. The virtual-machine monitor uses embodiments of the present invention by assigning pages containing these instructions to the suspect category, described below, in order to solve this problem.

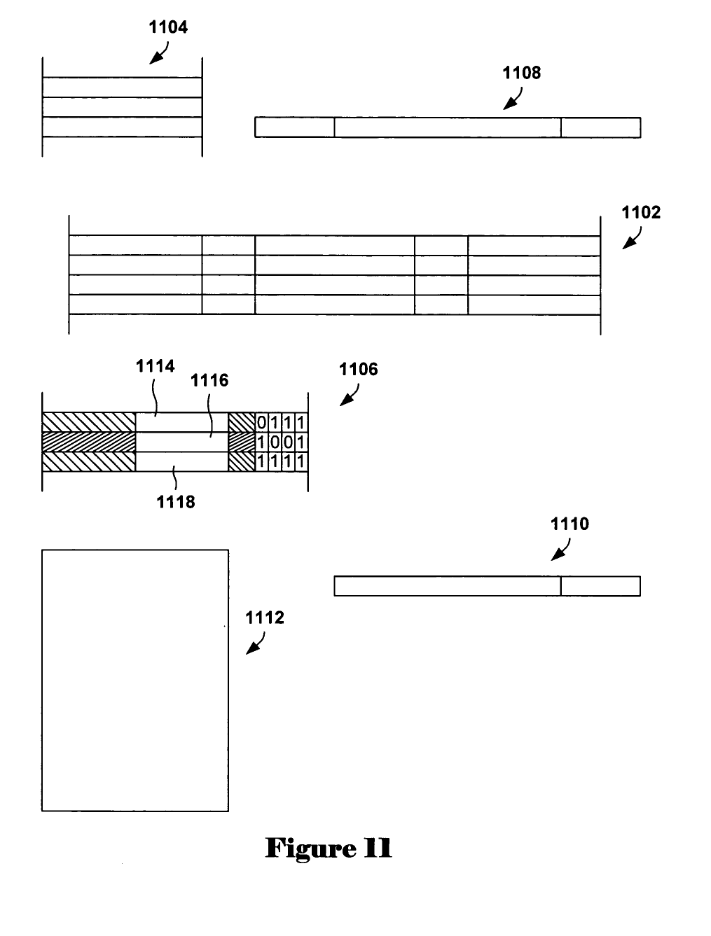

FIGS. 11-18 illustrate techniques used by a virtual-machine monitor for dynamic guest-operating-system code patching according to one embodiment of the present invention. FIGS. 11-18 all use the same illustration conventions, described below, with reference to FIG. 11. In FIG. 11, the various components of the virtual-address-translation mechanism, described above with reference to FIG. 5, are shown. These components include the translation lookaside buffer (“TLB”) 1102, a portion of the region registers 1104, a portion of the protection-key registers 1106, a virtual address to be translated 1108, a physical page address 1110 representing the translation of the virtual address 1108, and a graphical representation 1112 of the physical memory page addressed by the physical-page address 1110. As discussed above, with respect to FIG. 5, the TLB, protection-key registers, and region registers contain significantly more entries than shown in portions of these virtual-address-translation components in FIG. 11. In FIG. 11, the displayed portion of the protection-key registers 1106 include three, special protection-key-register values 1114, 1116, and 1118. The virtual-machine monitor uses these special protection-key-register values in order to assign guest-operating-system virtual-memory pages to one of three different protection domains implemented as protection-key domains. The first protection-key domain, associated with protection-key-register value 1114, is an execute-only domain. The protection-key-register value 1114 associated with the execute-only domain has both the write-disable and read-disable bits set, so that either read or write access to a virtual-memory page, including a key matching the key field of the protection-key-register value 1114, generates a key-permission fault that may be intercepted by a virtual-machine monitor. The second protection-key domain is a data-access-only domain, associated with the protection-key-register value 1116. The protection-key-register value 1116 associated with the data-access-only domain has the execute-disable bit set, as shown in FIG. 11, so that an attempt to execute a virtual-memory page, the translation of which includes the key contained in the key-field of the protection-key-register value 1116 generates a key-permission fault that can be intercepted by a virtual-machine monitor. In alternative embodiments, page-level access rights in virtual-address translations may be used, rather than protection-key-domain assignment, to protect a page from data access. In many cases, page-level access rights are more convenient for protecting pages from data access. A final protection-key domain, associated with the protection-key-register value 1118, is a no-access domain. All disabled bits within the protection-key-register value 1118 are set, so that any attempt to access a page in the no-access domain results in a key-permission fault that can be intercepted by a virtual-machine monitor. In alternative embodiments, the “p” bit of a TLB entry can be cleared to protect a page from all access, rather than using protection-key domains. In many cases, the “p” bit technique is more convenient. A virtual-machine monitor can assign any virtual-memory page to one of the three protection-key domains discussed above with reference to the three protection-key-register values 1114, 1116, and 1118 shown in a portion of the protection-key-registers 1106 in FIG. 11.

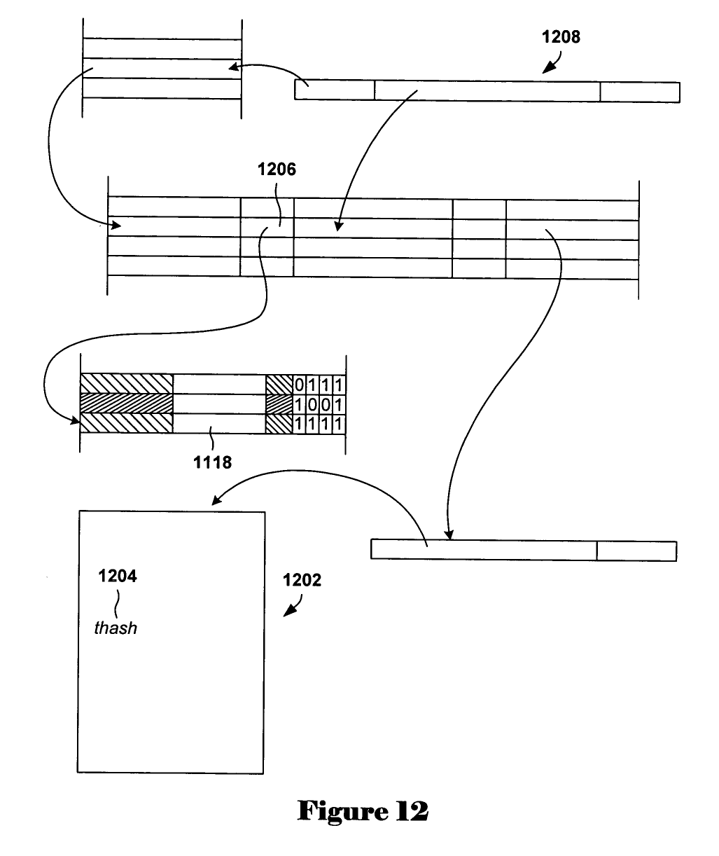

FIG. 12 illustrates use of the protection-key domains by a virtual-machine monitor for handling a suspect page. A suspect page is a virtual-memory page that cannot be unambiguously, through heuristics or application of a set of rules, determined to be either executable or a data page. A suspect page, such as the physical-memory page 1202 in FIG. 12, may contain what appears to be an instruction, such as the thash instruction shown in the physical memory page 1202 in FIG. 12 that needs to be patched for emulation by the virtual-machine monitor. However, as discussed above, it can be the case that what appears to be a thash instruction is simply a data value used for some non-executable-code purpose that happens to have the integer value that coincides with a well-formatted thash instruction. Lacking further clues, the virtual-machine monitor considers the physical-page 1202 to be a suspect page, which may be either a data page or an executable page, determinable only by subsequent use of the page by a guest operating system. A suspect page is assigned to the no-access domain by including a key 1206 in the translation for the virtual-page address 1208 for the page 1202 corresponding to the no-access protection-key-register value 1118.

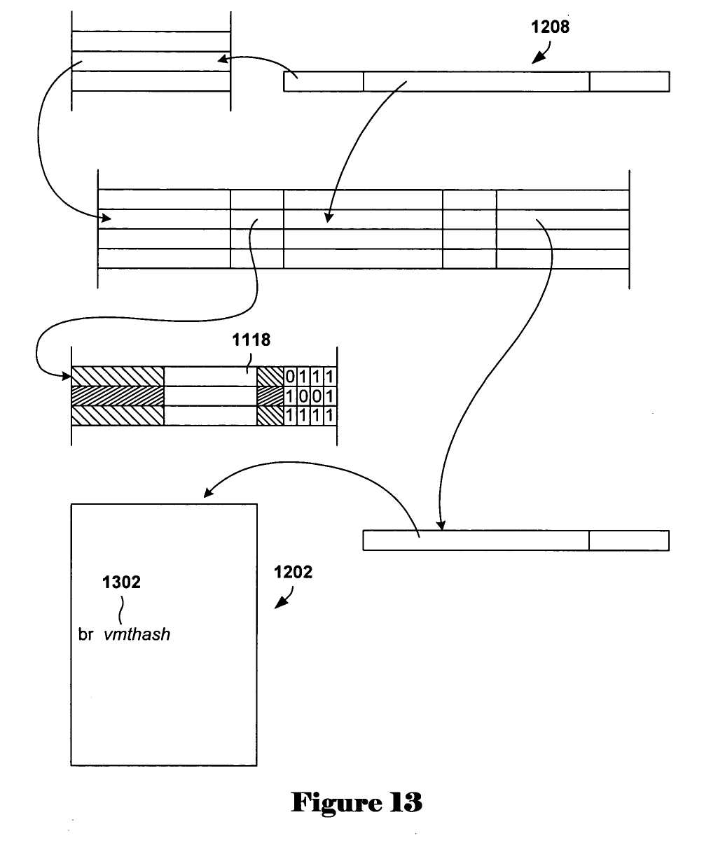

FIG. 13 illustrates resolution of a suspect page when the suspect page is attempted to be executed by a guest operating system. As shown in FIG. 13, the virtual-machine monitor patches any suspect instructions 1302 within the physical page 1202 corresponding to a virtual-page address 1208 and assigns the virtual-memory page, and corresponding physical memory page, to the execute-only domain specified by protection-key-register value 1118. In certain embodiments, the patching may be done at the time that a page is classified as a suspect page. In alternative embodiments, the patching is carried out at the point in time when execute access is attempted to the page. In either case, the suspect page is resolved to being an executable page, by patching and updating the virtual-address translation to assign the page to the execute-only protection-key domain.

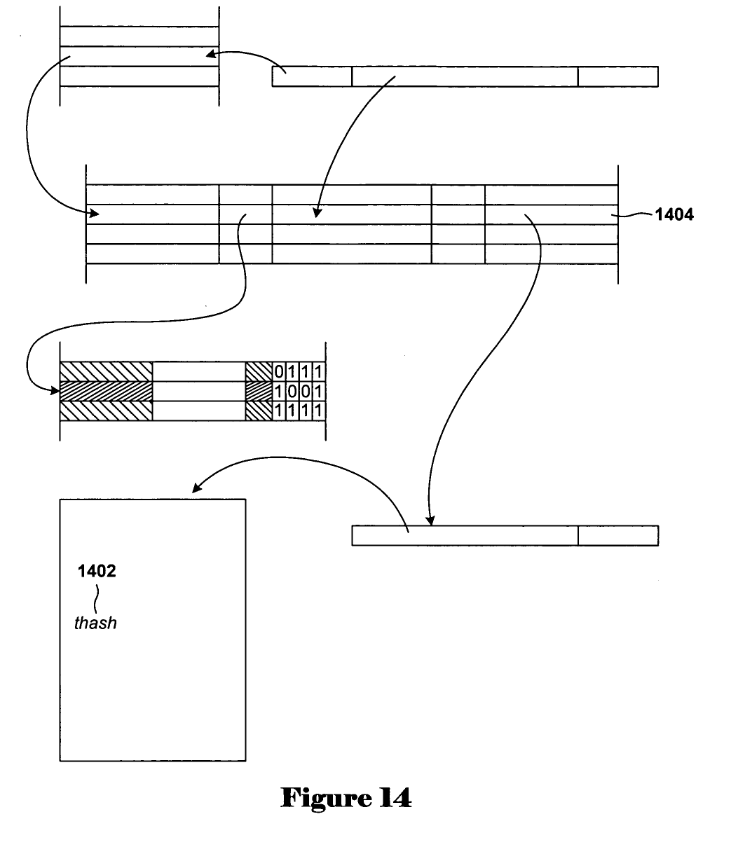

FIG. 14 illustrates resolution of a suspect page upon read-or-write-access to the suspect page. As shown in FIG. 4, suspect constructions are either restored to their original form 1402, in case patching is done at the time that a suspect page is recognized, or left unaltered, in the case that patching is done upon resolution. The virtual-address-translation 1404 for the virtual-memory page is updated to assign the virtual-memory page to the data-access-only protection-key domain.

Once a suspect page is resolved to being a data-access-only page, a guest operating system can freely access the page for read and write operations without generating a key-permission fault intercepted by the virtual-machine monitor. However, if the guest operating system attempts to subsequently execute the page result to be a data-access-only page, then a key-permission fault is generated, the fault intercepted by the virtual-machine monitor, and an appropriate action, to be discussed below, may be undertaken. Similarly, a suspect page resolved to be an execute-only page can be freely executed by a guest operating system, but if the guest operating system subsequently tries to access the execute-only page for read or write operations, a key-permission fault is generated that can be intercepted by the virtual-machine monitor, allowing the virtual-machine monitor to undertake appropriate actions, described below. Any access to a suspect page generates a key-permission fault, allowing the virtual-machine monitor to resolve the suspect page upon a first attempt to access the suspect page.

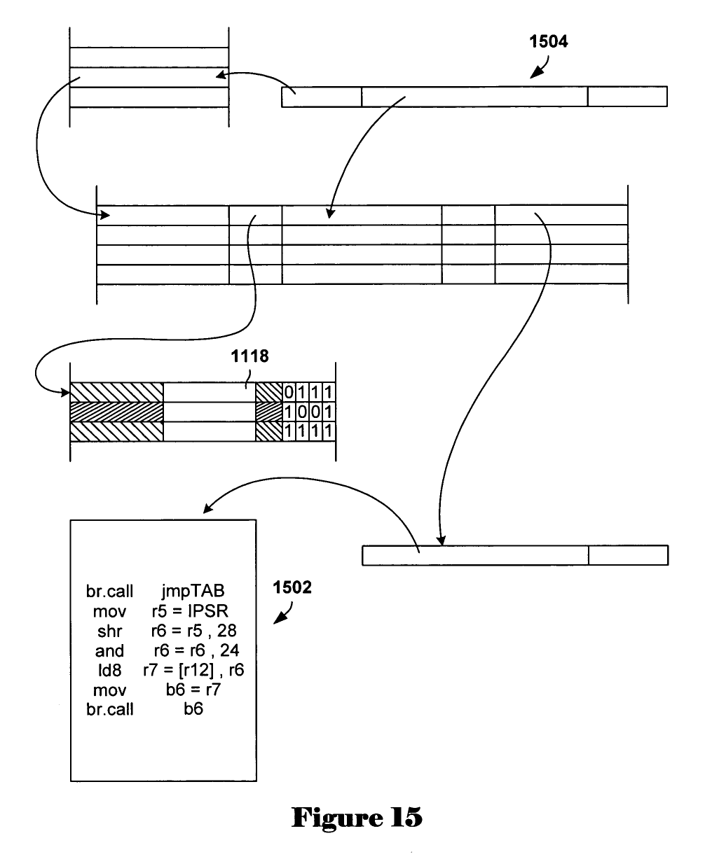

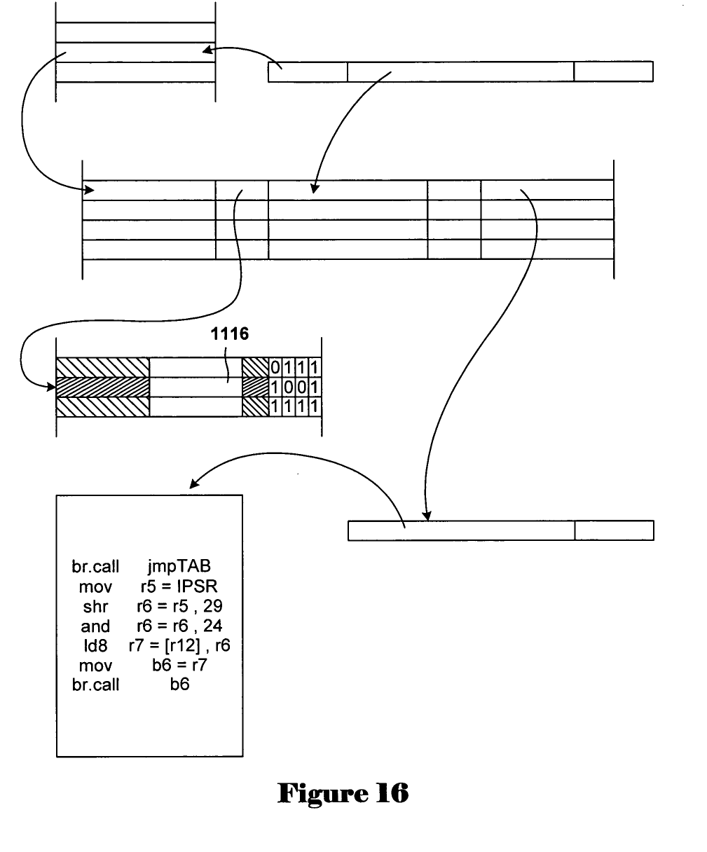

As discussed above, in many cases, a scan of a virtual-memory page, combined with application of heuristics or a set of rules, can often result in unambiguous or nearly unambiguous determination of whether or not the virtual-memory page is executable or represents a data page. FIG. 15 illustrates an immediate assignment of a virtual-memory page to executable status by a virtual-machine monitor. In FIG. 15, a physical-memory page 1502 addressed by a virtual-page address 1504 is seen to contain a series of instructions that a virtual-machine monitor can either recognize as a frequently occurring operating-system routine, or can infer, by a set of rules or heuristics, that the virtual-memory page has a high probability of containing executable code. In this case, the virtual-machine monitor can immediately assign the page to the execute-only protection-key domain associated with the protection-key-register value 1118. If, subsequently, an attempt is made to access the page for read or write operations, as shown in FIG. 16, the access attempt generates a key-permission fault intercepted by the virtual-machine monitor. The virtual-monitor fault handler then re-assigns the virtual-memory page to the data-access-only protection-key domain associated with the protection-key-register value 1116. The virtual-machine monitor also removes any patches introduced into the page, restoring the contents of the page to their original form. In alternative embodiments, the virtual-machine monitor may simply redirect access to a different physical-memory page containing the original contents of the virtual-memory page, leaving any patches in place. It should be noted that this technique allows a virtual-machine monitor to defeat an attempt by a guest operating system to easily determine whether or not the guest operating system is running in a virtual-monitor-provided virtual-machine environment. Were this technique not used, the guest operating system could select a virtual-memory page containing an instruction certain to be emulated by a virtual-machine monitor, and read the page to determine whether or not the instruction has been overwritten by a branch instruction directing execution to a virtual-monitor patch.

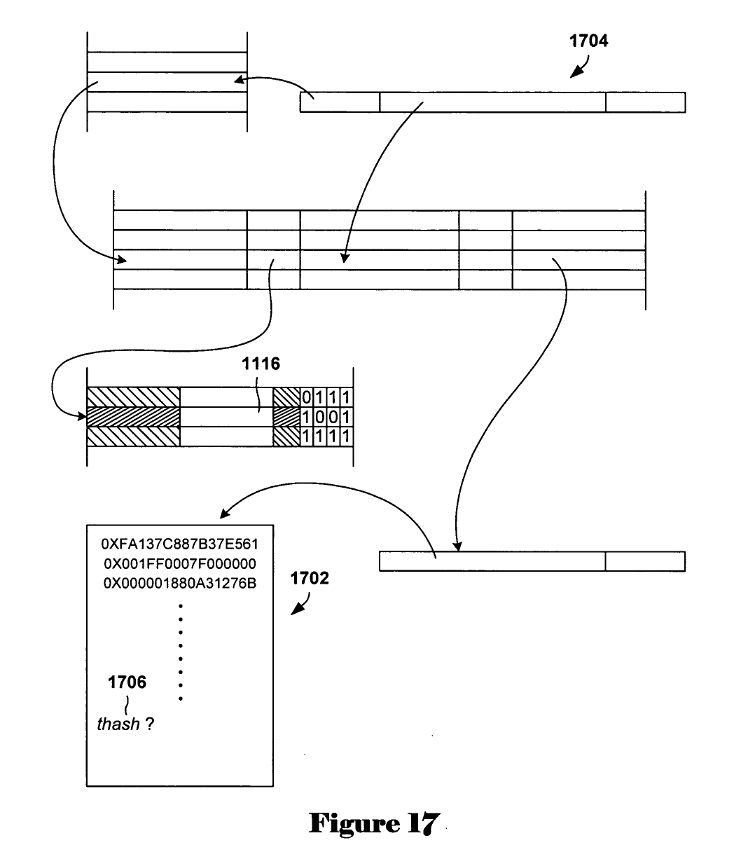

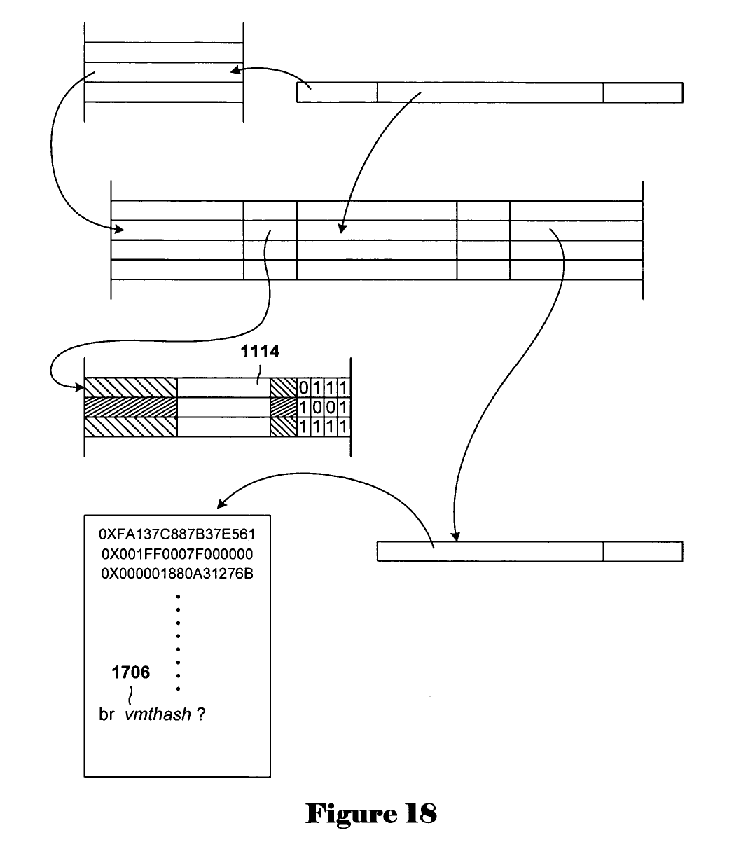

FIG. 17 shows initial assignment of a virtual-memory page to the data-access-only domain. As shown in FIG. 17, by applying heuristics or a set of rules to the contents of a virtual-memory page, a virtual-machine monitor may unambiguously or nearly unambiguously determine that the virtual-memory page represents a data page. In FIG. 17, physical page 1702 addressed to virtual-page address 1704 appears to contain a set of 64-bit data values that are not recognized as a coherent sequence of instructions. However, note that at least one value 1706 in the page coincides with the value of a thash instruction, which the virtual-machine monitor would normally emulate. Because indications are strong that the page is a data page, the virtual-machine monitor initially assigns the virtual-memory page to the data-access-only domain associated with the protection-key-register value 1116. If the guest operating system subsequently attempts to execute the page, as shown in FIG. 18, a key-permission fault is generated, and the virtual-machine monitor reassigns the page from the data-access-only domain to the execute-only protection-key domain associated with protection-key-register value 1114. In addition, the virtual-machine monitor patches the suspect instruction 1706.

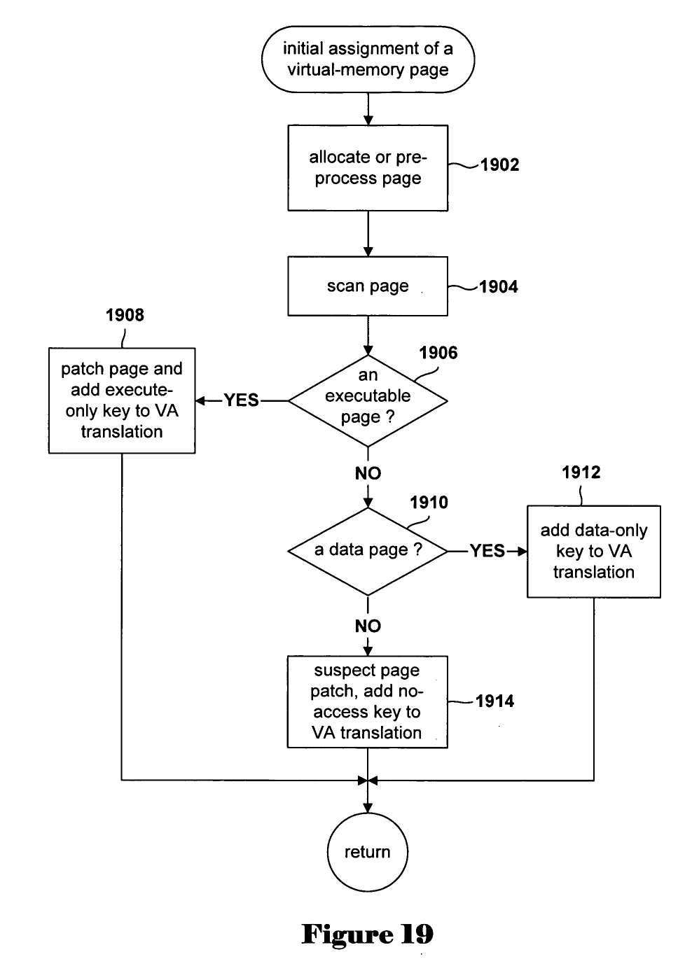

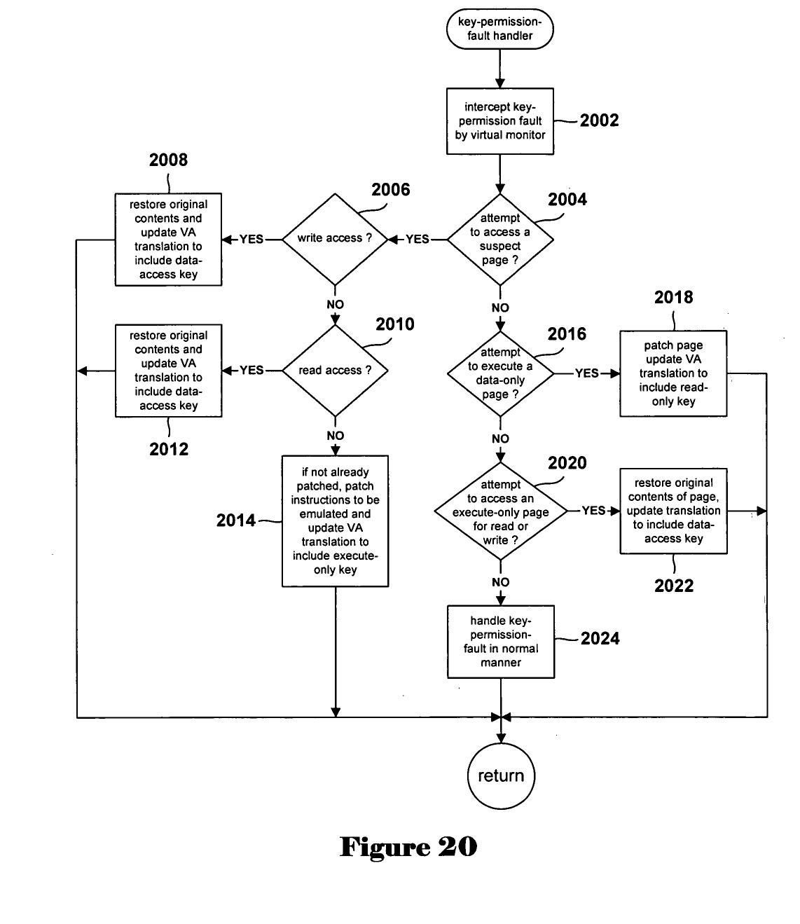

The methods described above, with reference to FIGS. 11-18, can be carried out by a virtual-machine monitor with the addition of logic at the point that virtual-memory pages are first allocated or otherwise processed by a virtual-machine monitor on behalf of the guest operating system, and within a key-permission fault handler invoked by key-permission faults. FIGS. 19 and 20 illustrate, using control-flow diagrams, the logic additions to initial-processing code and key-permission-fault handler code of a virtual-machine monitor in order to implement the described embodiment of the present invention.

FIG. 19 a control-flow diagram illustrating initial assignment of a virtual-memory page by a virtual-machine monitor to one of the three, above-described protection-key domains. In step 1902, a virtual-memory page is allocated or pre-processed by a virtual-machine monitor prior to an attempt by a guest operating system or other program to access or execute the virtual-memory page. In step 1904, the virtual-machine monitor scans the page, applying heuristics or a set of rules in order to determine whether the page is a data page, an executable page, or a page that cannot be unambiguously determined to be either executable or data. If application of the heuristics and/or set of rules determines the page is an executable page, in step 1906, then the virtual-machine monitor patches any apparent instructions within the page that need to be emulated and assigns the page to the execute-only protection-key domain by updating the key in the virtual-address translation for the page, in step 1908. Otherwise, if the page is determined to be a data page, in step 1910, then the virtual-machine monitor assigns the page to the data-access-only protection-key domain by updating the key field of the virtual-address translation for the page, in step 1912. Otherwise, the page is a suspect page, and the virtual-machine monitor assigns the page to the no-access protection-key domain by updating the key field in the virtual-address translation for the page, in Step 1914. As noted above, in an alternative embodiment, the suspect page is not patched at this point, but only patched later, when the suspect page is resolve by an execution access.

FIG. 20 is a control-flow diagram illustrating logic added to the key-permission-fault handler of a virtual-machine monitor to implement one embodiment of the present invention. In step 2002, the virtual-machine monitor intercepts a key-permission fault and invokes the virtual-monitors key-permission fault handler. In step 2004, the virtual-machine monitor determines whether the previously existing routine attempted to access a suspect page previously assigned by the virtual-machine monitor to the no-access protection-key domain. If so, then, in step 2006, the virtual-machine monitor determines whether a write access was attempted by the previously executing routine. If so, then the virtual-machine monitor restores the original contents of the page, if the page had been previously patched, and updates the virtual-address translation for the page to assign the page to the data-access-only protection key domain in step 2008. If, on the other hand, a read access was attempted, as determined in step 2010, then, in one embodiment, the virtual-machine monitor restores the original contents of the page, if the page had been previously patched, and updates the virtual-address translation for the page to place the page into the data-access-only key-protection domain, in step 2012. However, in alternative embodiments, the virtual-machine monitor may elect to redirect the read-access to a page containing the original contents of the memory page, or emulate the read instruction to return results expected by the guest operating system, but continue to consider the access virtual-memory page to be a suspect page, depending on the outcome of application of heuristics or other rules to the page. In other words, an attempted write access is a relatively clear indication that the virtual-memory page is a data page, although a read access may be carried out by a guest operating system or other routine or program to an executable page for various reasons. If all indications point to the page being an executable page, a virtual-machine monitor may elect to continue to consider the virtual-memory page a suspect page until subsequent access unambiguously resolves the page's role. Otherwise, an attempt has been made to execute a suspect page. If the page has not already been patched the virtual-machine monitor patches the page and updates the virtual-address translation for the page to assign the page to the execute-only protection-key domain, in step 2014. If the key-permission fault was generated by an attempt to execute a data access-only page, as determined in step 2016, then the virtual-machine monitor patches any instructions needed to be emulated in the page and updates the virtual-address translation for the page to assign the page to the execute-only protection-key domain, in step 2018. If, on the other hand, as determined in step 2020, an attempt was made to access an execute-only page for a read or write operation, then the virtual-machine monitor restores the original contents of the page and updates the virtual-address translation for the page to include the page in the data-access-only protection-key domain in step 2022. Otherwise, normal key-permission-fault-handling operations are undertaken in step 2024 to handle a key-permission fault that has occurred for reasons other than for patching the contents of virtual-memory pages by a virtual-machine monitor and monitoring patched pages.

Although the present invention has been described in terms of a particular embodiment, it is not intended that the invention be limited to this embodiment. Modifications within the spirit of the invention will be apparent to those skilled in the art. For example, an almost limitless number of different implementations of the present invention are possible to allow a virtual-machine monitor to monitor access operations directed to a virtual memory page to ensure that the contents of the virtual memory page are appropriate for the access operation. The protection-key mechanism can be used to assign virtual-memory pages to the various page-type categories at different points in a virtual-machine monitor, or at the points used in the above-described embodiments, but using different code development techniques, different control structures, different data structures, and other differences. It is possible that a virtual-machine monitor may identify additional possible roles for virtual-memory pages, and expand the number of protection-key domains to include those additional roles. As discussed above, patching may be aggressively applied both to executable pages and suspect pages upon initial categorization of virtual-memory pages, or may be applied for suspect pages only at the point that the suspect pages are resolved to be executable pages.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for monitoring access to a virtual-memory page by a virtual-machine monitor, the method comprising:
evaluating the virtual-memory page to determine an access type;
assigning the virtual-memory page to a protection domain corresponding to the determined access type; and
when an access operation is directed to the virtual-memory page that is incompatible with the assigned protection domain,
intercepting the access operation.

2. The method of claim 1 wherein evaluating the virtual-memory page to determine an access type further includes:
applying heuristics, logic rules, or a combination of heuristics and logic rules to values stored within the virtual-memory page to make an access-type determination;
when the access-type cannot be determined, assigning the virtual-memory page to a suspect access type.

3. The method of claim 2 wherein access types include data-only access, execution-only access, and suspect.

4. The method of claim 1 wherein assigning the virtual-memory page to a protection domain further includes placing a key into a virtual-address translation for the virtual-memory page corresponding to the protection domain.

5. The method of claim 4 wherein the key has a value equal to the value of the contents of a key field of a protection-key-register value having access-disable bits set to disable access other than the access type associated with the protection-key domain.

6. The method of claim 5 wherein:
the protection-key-register value corresponding to a data-access-only protection domain has an execution-disable bit set;
the protection-key-register value corresponding to a execution-access-only protection domain has a read-disable bit and a write-disable bit set;
the protection-key-register value corresponding to a suspect protection domain only has an execution-disable bit set, a read-disable bit, and a write-disable bit set.

7. The method of claim 1 wherein assigning the virtual-memory page to a protection domain further includes setting page-level access rights to disable access incompatible with the protection domain.

8. The method of claim 1 wherein assigning the virtual-memory page to a protection domain further includes setting a translation-lookaside-buffer-entry bit to disable access to the page.

9. The method of claim 1 wherein intercepting the data-access operation further includes detecting an attempt to direct an access-operation to the virtual-memory page incompatible with the access-type to which the virtual-memory page is assigned in a key-permission fault handler.

10. The method of claim 9 further including, when an attempt to direct a write operation to a virtual-memory page with an assigned suspect access type is detected:
assigning the virtual-memory page to a data-access-only access type; and
ensuring that the virtual-memory page contains no instruction-emulation patches.

11. The method of claim 9 further including, when an attempt to direct a read operation to a virtual-memory page with an assigned suspect access type is detected:
assigning the virtual-memory page to a data-access-only access type; and
ensuring that the virtual-memory page contains no instruction-emulation patches.

12. The method of claim 9 further including, when an attempt to direct an execute operation to a virtual-memory page with an assigned suspect access type is detected:
assigning the virtual-memory page to an execute-access-only access type; and
ensuring that the virtual-memory page contains needed instruction-emulation patches.

13. The method of claim 9 further including, when an attempt to direct a write operation to a virtual-memory page with an assigned execution only access type is detected:
assigning the virtual-memory page to a data-access-only access type; and
ensuring that the virtual-memory page contains no instruction-emulation patches.

14. The method of claim 9 further including, when an attempt to direct a read operation to a virtual-memory page with an assigned execution only access type is detected:
assigning the virtual-memory page to a data-access-only access type; and
ensuring that the virtual-memory page contains no instruction-emulation patches.

15. The method of claim 9 further including, when an attempt to direct an execution operation to a virtual-memory page with an assigned data-access-only access type is detected:
assigning the virtual-memory page to an execution-only access type; and
ensuring that the virtual-memory page contains needed instruction-emulation patches.

16. Computer-readable instructions encoded in a computer-readable medium that implement the method of claim 1.

17. A virtual-machine monitor that includes instructions that implement the method of claim 1.
